(19) United States
(12) Patent Application Publication
(10) Pub. No.: US 2007/0238521 A1
(43) Pub. Date: Oct. 11, 2007

(54) Video game braking control system

(75) Inventor: Hszang-Tang Yu, Chung Ho City (TW)

Correspondence Address: TROXELL LAW OFFICE PLLC;SUITE 1404, 5205 LEESBURG PIKE, FALLS CHURCH, VA, 22041, US

(73) Assignee: Sysgration Ltd.

(21) Appl. No.: 11/393,815

(22) Filed: Mar. 31, 2006

(51) Int. Cl. A63F 9/24; A63F 13/00

(52) U.S. Cl. 463/36; 463/37

(57) ABSTRACT

A video game braking control system includes a steering wheel adapted with a braking controller; a braking control chip being built in the braking controller to control the timing of consecutive braking of the racing car of the video game; and multiple control keys being disposed on the steering wheel and connected to the braking controller to regulate the execution and lapse of braking for making the car racing game even closer to the real situation.

### FIELD OF THE INVENTION

The present invention is related to a braking control system, and more particularly, to one adapted to a video game allowing easy operation and increasing the sense of real action while playing the game.

### BACKGROUND OF THE INVENTION

Referring to FIG. 1 of the accompanying drawings, the prior art includes a steering wheel 10 adapted to a video game control box 12. The control box 12 connects through a socket 14 to any existing game host including PS1, PS2, Nintendo, Microsoft XBOX generally available in the market today to control the vehicle in the game for having more exciting simulation of real action when compared with the use of keyboard. However, the playing process gets too monotonous by simply handling the steering wheel and too boring as time goes by to deliver the pleasant sensation.

### SUMMARY OF THE INVENTION

The primary purpose of the present invention is to provide a braking control system adapted to a video game to make the simulation of car racing even more real by taking advantage of a controller disposed on the steering wheel to regulate and control the time lapse of braking.

Another purpose of the present invention is to provide a braking control system adapted to a video game to regulate the braking lapse through a mechanical adjustment disposed on accelerator pedal of braking.

To achieve the purposes, the present invention includes a steering wheel provided with a braking controller. The braking controller contains a braking control chip to control the timing of consecutive braking of the racing car of the video game. Multiple control keys are disposed on the steering wheel and connected to the braking controller to regulate the execution and lapse of braking for making the car racing game even closer to the real situation.

### BRIEF DESCRIPTION OF THE DRAWINGS

FIG. 1 is a sectional view of the prior art.

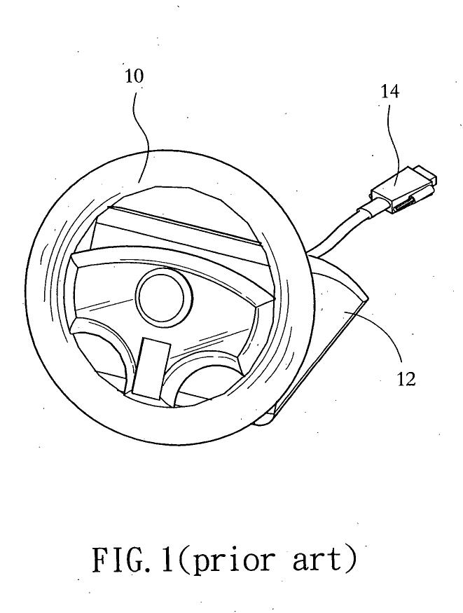

FIG. 2 is a schematic view of a preferred embodiment of the present invention.

FIG. 3 is a perspective view of another preferred embodiment of the present invention.

### DETAILED DESCRIPTION OF THE PREFERRED EMBODIMENTS

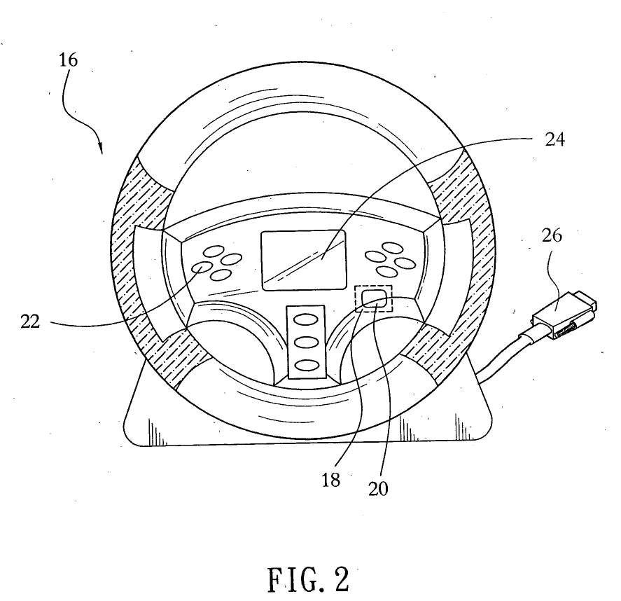

Referring to FIG. 2, a braking control system of a game of the present invention includes a steering wheel 16, a braking controller 18 is adapted to the steering wheel 16, a braking control chip 20 is disposed to the braking controller 18; multiple control keys 22 connected to the braking controller 18 are disposed on the steering wheel 16; a liquid crystal display 24 to display the control status of the braking controller 18; and an adapter 26 is disposed on the steering wheel 16 to connect to game hosts generally available in the market today including PS1, PS2, and Nintendo, or a home PC to control the vehicle in the game for making the play even real. During playing the game, the braking controller 18 is regulated through those control keys 22 disposed on the steering wheel 16 to execute the real car ABS-Anti-lock Braking System in the steps to be described below. Upon pressing those control keys 22 to execute braking, signals of braking are converted into intermittent braking action through the braking control chip 20 to execute braking. The time length of braking and the braking lapse regulated through those control keys 22 can be seen on the liquid crystal display 24.

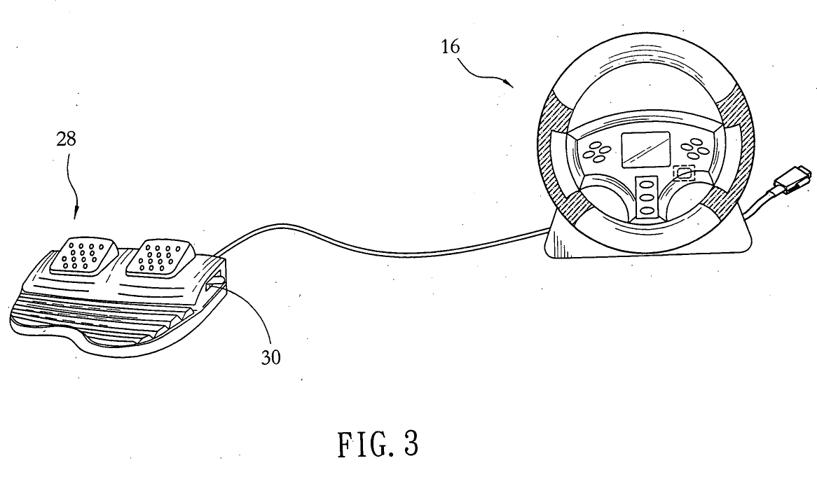

As illustrated in FIG. 3, another preferred embodiment of the present invention is further provided with a braking accelerator pedal 28 and a mechanical adjustment 30 is disposed on the braking accelerator pedal 28. The braking accelerator pedal 28 is connected to the steering wheel 16 to take over the control of braking from those control keys 22 disposed on the steering wheel 16. Meanwhile, the mechanical adjustment 30 is able to regulate the time length of applying the braking and the adjust the lapse of the braking by stage for the optimal mode that suits best the player to deliver the more real sensation of racing the car.

The prevent invention provides a braking control system adapted to a video game, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A video game braking system includes a steering wheel, a braking controller adapted to the steering wheel, the braking controller containing a braking control chip to regulate consecutive braking time of a racing car in the game, and multiple control keys disposed on the steering wheel and connected to the braking controller to select and regulate the lapse of braking.

2. The video game braking system of claim 1, wherein a liquid crystal display is further provided on the steering wheel to display the time lapse of the braking executed by the braking controller.

3. The video game braking system of claim 1, wherein the braking controller chip controls the time length of the braking executed.

4. The video game braking system of claim 1, wherein the braking control chip regulates the time lapse of the braking executed.

5. The video game braking system of claim 1, wherein an accelerator step of braking is further provided.

6. The video game braking system of claim 5, wherein a mechanical adjustment is disposed on the accelerate pedal to regulate the time lapse of the braking executed.

7. The video game braking system of claim 1, wherein an extension of adapter is disposed to the steering wheel for executing signals transmission to a game box or PC.
